(19) United States
(12) Patent Application Publication
(10) Pub. No.: US 2026/0346777 A1
(43) Pub. Date: Nov. 5, 2026

(54) MULTI-BED DUMP SYSTEM

(71) Applicant: Multi Dump Technologies LLC, Goodyear, AZ (US)

(72) Inventor: Quinten JARVIS, Goodyear, AZ (US)

(21) Appl. No.: 19/741,710

(22) Filed: Jul. 14, 2026

Related U.S. Application Data
(63) Continuation of application No. 18/827,509, filed on Sep. 6, 2024.
Application No. 18/827,509 is a continuation-in-part of application No. 18/122,080, filed on Mar. 15, 2023.
Application No. 18/122,080 is a continuation-in-part of application No. 16/914,076, filed on Jun. 26, 2020, now Pat. No. 11,607,983.
(60) Provisional application No. 62/868,695, filed on Jun. 28, 2019.

(51) Int. Cl. B60P 1/28; B60P 1/16

(52) U.S. Cl. CPC B60P 1/286; B60P 1/162

(57) ABSTRACT

A device may include a frame and a subframe over the frame. A forward dump bed is coupled to the subframe, wherein the forward dump bed has one or more doors arranged in a most rearward wall of the forward dump bed. The device may include a rearward dump bed coupled to the subframe, wherein the rearward dump bed has one or more doors arranged in a most forward wall of the rearward dump bed. The device may include a first lift mechanism connected to the forward dump bed and configured to raise at least a portion of the forward dump bed to dump material in the forward dump bed in a sideways direction. The device may include a second lift mechanism configured to raise the subframe to dump material in a rearward direction from at least one of the forward dump bed and the rearward dump bed.

### CROSS-REFERENCE TO RELATED APPLICATIONS

This application is a Continuation of U.S. patent application Ser. No. 18/827,509, entitled “Multi-Bed Dump Trailer” and filed on Sep. 6, 2024, which is a Continuation-in-part of and claims priority to U.S. patent application Ser. No. 18/827,509, entitled Multi-Bed Dump Trailer and filed on Sep. 6, 2024, which is a Continuation-in-part of U.S. patent application Ser. No. 18/122,080 entitled Multi-Bed Dump Trailer and filed on Mar. 15, 2023, which claims priority to U.S. patent application Ser. No. 16/914,076 entitled Multi-Bed Dump Trailer and filed on Jun. 26, 2020, now U.S. Pat. No. 11,607,983 issued on Mar. 21, 2023, which claims priority to U.S. Provisional Patent Application No. 62/868,695 entitled Multi-Bed Dump Trailer and filed on Jun. 28, 2019, the contents of which are all incorporated herein by reference in their entireties.

### FIELD OF THE INVENTION

The present invention generally relates to a multi-bed dump trailer and, more specifically, to a multi-bed dump trailer where a forward dump bed can dump sideways in a first configuration, a rearwards dump bed can dump rearwards in a second configuration and the forward dump bed and the rearward dump bed can both dump rearward at the same time in a third configuration.

### BACKGROUND

A trailer is a device for hauling material which may be towed by a vehicle. For hauling loose material (e.g. gravel, rocks, mulch, sand), a trailer may be configured with a dump bed. A dump bed may be tilted by raising one side. Tilting a dump bed may allow the hauled material to be distributed from the bed onto a work site without needing to manually remove the material (e.g. by shoveling) from the bed.

A work task may include hauling and dumping two or more different loose materials. These different materials may need to be applied to the work site in a specific order (e.g. soil first, then mulch over the soil). With a standard single-bed dump trailer, this task cannot readily be accomplished in a single trip: loading a second material over a first material in a single dump bed will cause mixing of the first and second materials. Load mixing can be reduced by using a tarp or plywood divider between the two or more materials, but this is often 7impractical. Thus, a single bed dump trailer may necessitate two trips for a two-material job, even if the total amount of material is within the capacity of the dump bed. These additional trips may waste time and fuel. For this and other reasons, a multi-bed dump trailer is proposed.

### SUMMARY OF THE INVENTION

This Summary section is neither intended to be, nor should be, construed as being representative of the full extent and scope of the present disclosure. Additional benefits, features and embodiments of the present disclosure are set forth in the attached figures and in the description hereinbelow, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

A multi-bed dump trailer may include a forward dump bed, a rearward dump bed, a subframe for connecting the forward dump bed and the rearward dump be, a frame for supporting the subframe and a plurality of wheels, a forward lift mechanism connected to the forward dump bed and a rearward lift mechanism connected to the subframe. The multi-bed dump trailer is configured to dump material in the forward dump bed sideways at a first time, dump material in the rearward dump bed rearward at a second time and dump material in the forward dump bed and the rearward dump bed rearward at a third time, wherein the first time, second time and third time are at different times.

The present invention generally relates to a multi-bed dump trailer. The multi-bed dump trailer may include a forward dump bed, wherein the forward dump bed has one or more doors arranged in a most rearward wall of the forward dump bed. The multi-bed dump trailer may also include a rearward dump bed, wherein the rearward dump bed may have one or more doors arranged in a most forward wall of the rearward dump bed. In preferred embodiments, the forward dump bed and rearward dump bed are shaped as open boxes or rectangular prisms.

The multi-bed dump trailer may also include a subframe, wherein the forward dump bed and the rearward dump bed are securely connected to the subframe. The subframe is preferably metal as it supports the weight of the forward dump bed and the rearward dump bed and any material therein. The subframe may comprise four metal members connected to form a hollow rectangle shape, preferably the same width, but shorter, than the trailer it lays on.

The subframe may be connected to the frame by any desired means, but is preferably connected by hinges or other mechanical means on the rearward side which allow a forward part of the subframe to be raised while pivoting on the rearward side, thereby tilting the subframe, the forward dump bed and the rearward dump bed in a rearward direction. This allows the forward dump bed and the rearward dump bed to be raised, i.e., tilted, and lowered on the subframe at the same time with the rearward lift mechanism.

The multi-bed dump trailer may also have a frame for supporting the subframe and a plurality of wheels that allow the multi-bed dump trailer to be pulled behind a vehicle.

The multi-bed dump trailer may have a first configuration where a forward lift mechanism is connected to the forward dump bed and configured to raise one of either a left side or a right side of the forward dump bed to dump material in the forward dump bed in a sideways direction in relation to the multi-bed dump trailer.

The multi-bed dump trailer may have a second configuration where a rearward lift mechanism is connected to the subframe and is configured to raise a front of the subframe to dump material in the forward dump bed and the rearward dump bed in a rearward direction at the same time when the one or more doors of the forward dump bed and the one or more doors of the rearward dump bed are open.

The multi-bed dump trailer may have a third configuration where the rearward lift mechanism is connected to the subframe and is configured to raise the front of the subframe to dump material in the rearward dump bed only, but not the forward dump bed, in a rearward direction when the one or more doors of the forward dump bed and the one or more doors of the rearward dump bed are closed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a side view of an embodiment of multi-bed dump trailer, with dump beds in lowered position and loading chute in raised position.

FIG. 2 is a frontal view of multi-bed dump trailer, with dump beds in lowered position and loading chute in a raised position.

FIG. 3A is a partial side view of multi-bed dump trailer with loading chute in intermediate position.

FIG. 3B is a partial side view of multi-bed dump trailer with loading chute in lowered position.

FIG. 4A is a simplified schematic underside view of a multi-bed dump trailer with dump beds in lowered position.

FIG. 4B is a simplified schematic top view of a multi-bed dump trailer with dump beds in lowered position.

FIG. 5 is a rear-side view of multi-bed dump trailer with dump beds in raised position.

FIG. 6 is a partial upper-side view of components of a multi-bed dump trailer underneath a raised dump bed.

FIG. 7A shows a first controller for a bed of multi-bed dump trailer.

FIG. 7B shows a second controller for a bed of multi-bed dump trailer.

FIG. 8 is a front-side view of an embodiment of a multi-bed dump trailer, with tandem rear-dump beds in partially-raised position and forward deck ramp in closed position.

FIG. 9 is a rear-side view of multi-bed dump trailer with tandem rear-dump beds in partially-raised position and forward deck ramp in closed position.

FIGS. 10A and 10B depict a simplified illustration of a trailer (e.g., trailer 100 of FIGS. 1 and 2) including a chute actuation system.

FIG. 11 depicts an example trailer system that includes three dump beds.

FIGS. 12A and 12B depicts a perspective and side views, respectively, of a fall-through protector.

FIG. 13 is a simplified schematic underside view of a multi-bed dump trailer with dump beds in a lowered position that uses one or more electromagnetic rams to lift one or more corresponding dump beds.

FIG. 14 depicts a vehicle with a hitch mount configured to be connected to a hitch on a trailer and, to improve stability, two eddy current sway bars are also used to connect the vehicle to the trailer.

FIG. 15 depicts an example of an eddy current tube with an inserted end (the end with a magnet) of an eddy current sway bar.

FIG. 16 is a cross section view of a magnet end of an eddy current sway bar inside an eddy current tube.

FIG. 17 is a side view of a multi-bed dump trailer with the forward dump bed and rearward dump bed in lowered positions.

FIG. 18 is a side view of a multi-bed dump trailer with the forward dump bed and the rearward dump bed in a raised position to dump material from the forward dump bed and the rearward dump bed when the forward dump bed door(s) and the rearward dump bed door(s) are open (preferably with the seal insert installed between the forward dump bed and the rearward dump bed) and to dump material from only the rearward dump bed when the forward dump bed door(s) and the rearward dump bed door(s) are closed.

FIG. 19 is a rearward view of a multi-dump trailer with the forward dump bed in a raised sideways position to dump material sideways from the forward dump bed and the rearward dump bed is in a lowered position to not dump material.

FIG. 20 is a side view of a seal insert that may be installed between the forward dump bed and the rearward dump bed.

FIG. 21 is a perspective view of the seal insert illustrated in FIG. 17 and FIG. 20.

FIG. 22 is a top front left perspective view of a poly bed that may be used in any of the bed configurations of the trailer.

FIG. 23 is a bottom side left perspective view of the poly bed in FIG. 22.

### DETAILED DESCRIPTION OF THE ILLUSTRATED EMBODIMENTS

The present invention generally relates to a multi-bed dump trailer and, more specifically, to a multi-bed dump trailer where a forward dump bed can dump sideways in a first configuration, a rearwards dump bed can dump rearwards in a second configuration and the forward dump bed and the rearward dump bed can both dump rearward at the same time in a third configuration.

A multi-bed dump trailer may have more than one bed. Each bed may be a dump bed, a fixed bed, a loading deck, or any configuration of trailer bed. The multiple beds may be in a variety of spatial arrangements. A multi-bed dump trailer may have a forward bed and a rearward bed or may have two side-by-side beds, or may have two side-by-side rearward beds and a forward bed, or may have two side-by-side forward beds and a rearward bed, or any arrangement of beds. The beds may be rectangular, triangular, or any shape. The beds may be arranged to provide improved trailer stability during a dumping operation.

One or more removable dump boxes that may be placed on a standard flatbed platform or be placed on the dump beds 102 and 154 of the trailer 100 as a liner. The one or more removable dump boxes may be placed in different dump beds 102 and 154 (assuming the removable dump boxes are smaller than the dump beds 102 and 154) to create various options and configurations for hauling different materials. In some embodiments, the dump boxes may have lids, thereby giving the open trailer 100 the advantages (weather and theft protection) of having an enclosed trailer.

In some aspects, the techniques described herein relate to a device, including: a frame; a subframe over the frame; a forward dump bed coupled to the subframe, wherein the forward dump bed has one or more doors arranged in a most rearward wall of the forward dump bed; a rearward dump bed coupled to the subframe, wherein the rearward dump bed has one or more doors arranged in a most forward wall of the rearward dump bed; a first lift mechanism connected to the forward dump bed and configured to raise at least a portion of the forward dump bed to dump material in the forward dump bed in a sideways direction; and a second lift mechanism configured to raise the subframe to dump material in a rearward direction from at least one of the forward dump bed and the rearward dump bed.

In some aspects, the techniques described herein relate to a device, further including a seal insert installed between the forward dump bed and the rearward dump bed.

In some aspects, the techniques described herein relate to a device, wherein the forward lift mechanism is a scissor lift mechanism.

In some aspects, the techniques described herein relate to a device, wherein the rearward lift mechanism is a piston lift mechanism.

In some aspects, the techniques described herein relate to a device, wherein at least one of the forward lift mechanism and the rearward lift mechanism includes an electromagnetic ram.

In some aspects, the techniques described herein relate to a device, wherein the forward dump bed is configured to be tilted towards one of its sides to dump material in a sideways direction at a first time and tilted towards a rearwards direction to dump material in a rearward direction in relation to the frame at a second time.

In some aspects, the techniques described herein relate to a device, wherein the frame is configured to couple to a vehicle.

In some aspects, the techniques described herein relate to a device, wherein the frame is coupled to a vehicle via a hitch connection or a direct connection mounting the device to the bed of a vehicle.

In some aspects, the techniques described herein relate to a device, wherein at least one of the forward dump bed and the rearward dump bed includes a poly material.

In some aspects, the techniques described herein relate to a device, wherein the poly material includes polyethylene or polypropylene.

In some aspects, the techniques described herein relate to a device, including: a metal frame; a first dump bed coupled to the frame substantially near a forward end of the frame, wherein the first dump bed is configured to dump materials toward a side of the device; and a second dump bed coupled to the frame substantially near a rearward end of the frame.

In some aspects, the techniques described herein relate to a device, further including: a first lift mechanism coupled to the first dump bed and a second lift mechanism coupled to the second dump bed.

In some aspects, the techniques described herein relate to a device, wherein the first dump bed is coupled to the metal frame by a first hinge and the second dump bed is coupled to the metal frame by a second hinge and a first axis of the first hinge is perpendicular to a second axis of the second hinge.

In some aspects, the techniques described herein relate to a device, wherein the first dump bed includes a first plurality of walls and a first wall of the first plurality of walls includes a first door, the first wall of the first plurality of walls being parallel to a length of the device.

In some aspects, the techniques described herein relate to a device, wherein the second dump bed includes a second plurality of walls and a second wall of the second plurality of walls includes a second door, the second wall of the second plurality of walls being perpendicular to the length of the device.

In some aspects, the techniques described herein relate to a device, wherein a maximum distance between the first wall of the first dump bed and the second wall of the second dump bed is less than 3 feet.

In some aspects, the techniques described herein relate to a device, wherein at least one of the forward dump bed and the rearward dump bed includes a poly material.

In some aspects, the techniques described herein relate to a device, wherein the poly material includes polyethylene or polypropylene.

In some aspects, the techniques described herein relate to a device, wherein the frame is configured to couple to a vehicle via a hitch connection or is mounted to the bed of a vehicle.

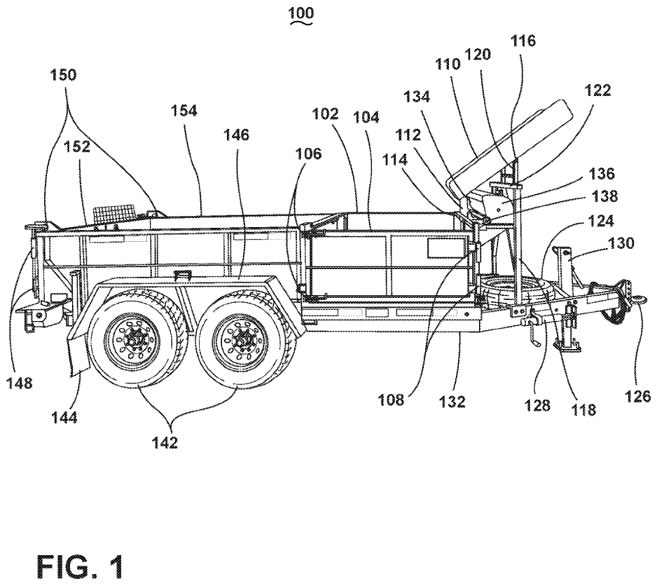

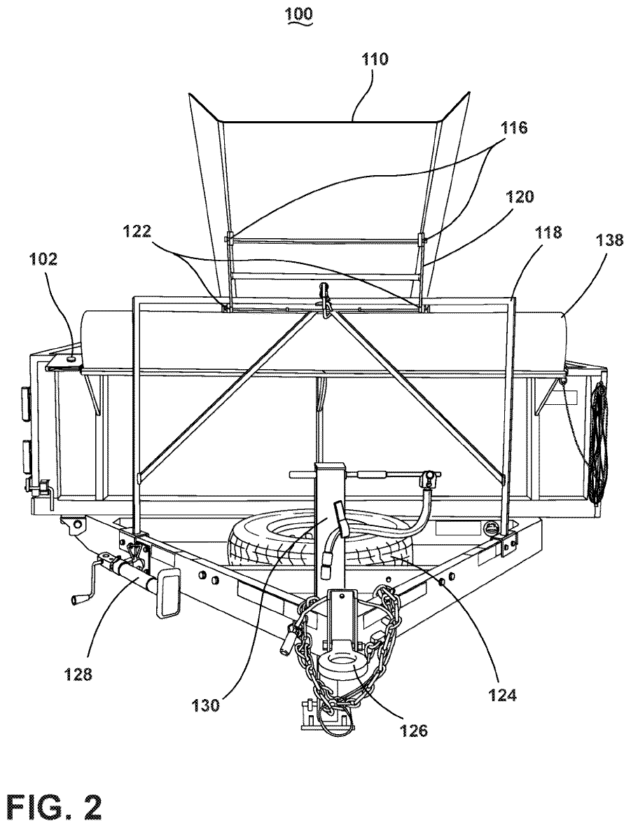

As shown in FIGS. 1 and 2, a multi-bed dump trailer 100 may have a forward dump bed 102 and a rearward dump bed 154. The forward dump bed 102 may be a side-dumping bed (e.g., configured to dump over a side of trailer 100), or any configuration of bed positioned towards the hitch 126 (i.e., front or forward end) of trailer 100. The rearward dump bed 154 may be a rear-dumping bed (e.g., configured to dump over a rear of trailer 100), a side-dumping bed, or any configuration of bed positioned away from the hitch 126 towards the rear for rearward end of trailer 100.

The forward dump bed 102 may have a forward dump gate 104. The forward dump gate may comprise one or more forward gate hinges 108 and one or more forward gate latches 106. The forward dump gate 104 may be a single door gate, with the hinges 108 and latches 106 placed on opposing sides of the gate. The forward dump gate 104 may be a barn door gate, a truck bed gate, a spreader gate, a mesh gate, or any kind of gate. The rearward dump bed 154 may have a rearward dump gate 152. The rearward dump gate may be a barn door gate, with hinges 148 on both the left and right sides of the gate and an opening in the center with latches. The rearward dump gate 152 may be a single door gate, a truck bed gate (e.g., with a hinge to connect a bottom edge of dump gate 152 to trailer 100), a spreader gate, a mesh gate, or any kind of gate.

The frame 132 may be constructed of any form of metal, with example frame materials including steel and aluminum, and example frame material shapes including channel, I-beam, and tubular.

A roll tarp 134 may be attached to the forward end of a multi-bed dump trailer 100. The roll tarp 134 may be unrolled into an extended position, to cover one or more loaded dump beds 102 and 154 during hauling, to prevent material from exiting the dump beds 102 and 154 during hauling. The roll tarp 134 may be rolled up into a rolled position, so that the roll tarp 134 does not block the operation of the dump beds 102 and 154 during loading or unloading. When the roll tarp 134 is in the rolled position, it may be covered by a tarp housing 136. The tarp housing 136 may include a central shaft around which the roll tarp 134 is wound when in the rolled position. The central shaft may be coupled within the tarp housing 136 by a spring mechanism, which may serve to automatically retract the roll tarp 134. The roll tarp 134 may be coupled to a tarp bar 138, which may serve as a support for the rearward end of the roll tarp 134. The tarp bar 138 may be configured to reversibly couple into tarp bar holders 150. Tarp bar holders 150 may be attached on the rearward end of the multi-bed dump trailer 100. The tarp bar 138 may be attached to a tarp bar rope, which may provide a handle for a user to pull the tarp bar 138 more easily from a standing position beside the multi-bed dump trailer 100. Tarp housing 136 may be coupled to forward dump bed 102, or may be coupled to swing arm support 118, or may be coupled any supporting structure.

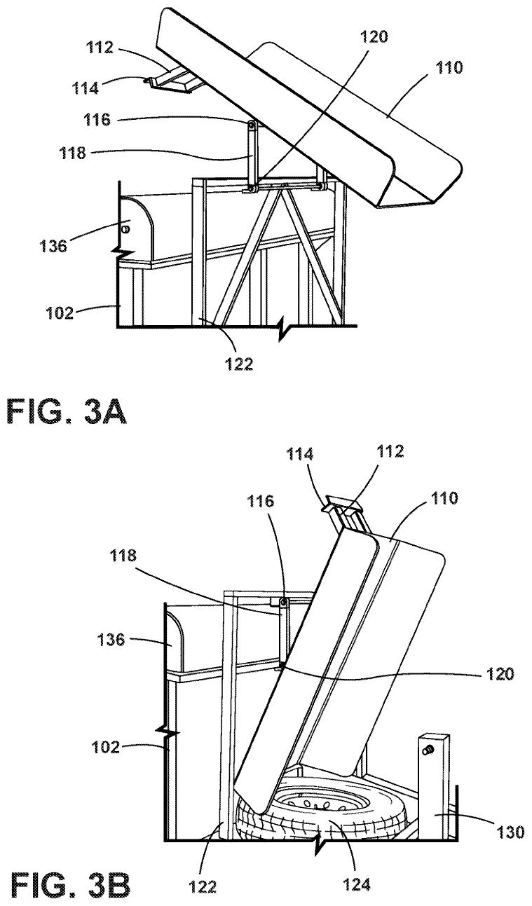

The multi-bed dump trailer 100 may include a loading chute 110. The loading chute 110 may be configured to aid in loading a forward dump bed 102. Equipment used to load a trailer, such as a front-end loader or a skid steer, may have a bucket which is wider than the length of the forward dump bed 102. Dumping from a wider bucket may cause undesired overflow or scattering of material. The loading chute 110 may be placed over a side of the forward dump bed 102 to direct material into the forward dump bed 102. The loading chute 110 may selectively be raised into a raised position above the forward dump bed 102 (e.g. during a loading operation) or lowered into a lowered position out of the path of the dump bed (e.g. during a dumping operation or hauling operation). The chute-raised position is depicted in FIGS. 1 and 2. The chute-lowered position is depicted in FIG. 3B. An intermediate position, as during a raising or lowering operation, is depicted in FIG. 3A.

A chute brace 114 may be used to support the chute 110 when the chute 110 is placed in the raised position. The chute brace 114 may be a section of L-shaped or angled metal. The chute brace 114 may be configured to rest against an upper side of the forward dump bed 102. The chute brace 114 may be coupled to a chute brace arm 112 on one end of the chute brace arm 112. The opposite end of the chute brace arm 112 may be coupled to the chute 110 and may be substantially near to an end of the chute 110.

The chute 110 may be rotationally coupled to a swing arm 120 by one or more chute hinges 116. The swing arm 120 may be rotationally coupled to a swing arm support 118 by one or more swing arm hinges 122. The swing arm support 118 may be rigidly coupled to the frame 132. The two rotational couplings 116 and 122 on opposing ends of the swing arm 120 allow the swing arm 120 to be pivoted and moved from the lowered position (e.g. FIG. 3B), to an intermediate position (e.g. FIG. 3A), to a raised position (e.g. FIG. 2). In the lowered position, the chute 110 may rest against the swing arm support 118. A strap, belt, cord, or other means may be used to selectively attach the chute 110 in the lowered position to the swing arm support 118.

In an embodiment, a bottom surface chute 110 may have a width of approximately 4 feet, with edges having widths of approximately 6 inches formed at a 45-degree angle with the bottom surface.

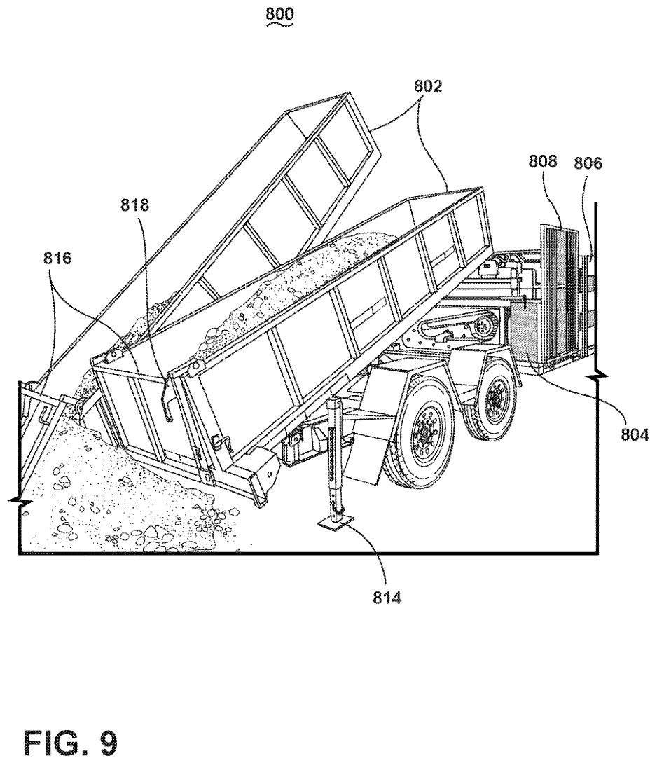

The chute 110 may be positioned manually. Or, in some embodiments, an actuation mechanism (e.g., an electric motor or pneumatic control system) is coupled to chute 110 enabling powered movement of chute 110. In still further embodiment, a jack-based actuation mechanism may be utilized to control a position of chute 110. For example, FIGS. 10A and 10B depict a simplified illustration of a trailer 1000 (e.g., trailer 100) including a chute actuation system. Trailer 1000 includes a frame 1002 (e.g., frame 132) and forward and rearward dump beds 1004, 1006 (e.g., forward dump bed 102 and rearward dump bed 154), respectively. Trailer 1000 includes chute 1008 (e.g., chute 110). Chute 1008 is connected to support strut 1010 at a hinge 1007 enabling chute 1008 to rotate with respect to support strut 1010. An extendable strut 1012 is connected to chute 1008. As the length of extendable strut 1012 is increased or decreased, chute 1008 can be rotated with respect to frame 1002. This enables chute 1008 to be positioned in a loading position (as depicted in FIG. 10A) by extending extendable strut 1012, thereby enabling material to be loaded into forward dump bed 1004. Alternatively, extendable strut 1012 can be shortened, enabling chute 1008 to be positioned in a “travel position”, such as that shown in FIG. 10B.

Extendable strut 1012 may be operated manually. In that case, extendable strut 1012 can be extended or retracted, by hand, to a desired length and then can be locked into position (thereby inhibiting change to a length of extendable strut 1012) to provide a desired function. In other cases, extendable strut 1012 may be operated by a mechanism such as a jack or pneumatic actuator to enable powered control over the length of extendable strut 1012 and, in turn, the position of chute 1008 with respect to frame 1002 of trailer 1000.

Returning to FIGS. 1 and 2, the frame 132 may be coupled to fenders 146 on each side. Fenders 146 may be placed above wheels 142. Mud flaps 144 may be coupled to rear side of fenders 146. The frame 132 may be connected to a hitch 126 at the forward end. The hitch 126 may be an adjustable hitch. The hitch 126 may be any configuration of hitch mechanism, including ball hitch, pintle hook hitch, gooseneck hitch, and fifth wheel hitch mechanism. The hitch may serve to provide a point of attachment for a vehicle which may tow the multi-bed dump trailer 100.

The vehicle may also be attached to the trailer via two sway bars. Sway bars (also known as anti-sway bars, anti-roll bars or a stabilizer bar) may be a part of a vehicles suspensions that helps reduce body roll of a towed vehicle or trailer during fast cornering or over road irregularities. Each of the two sway bars may be securely attached to a hitch mount on the vehicle and a left front portion and a right front portion of the trailer 100 respectively.

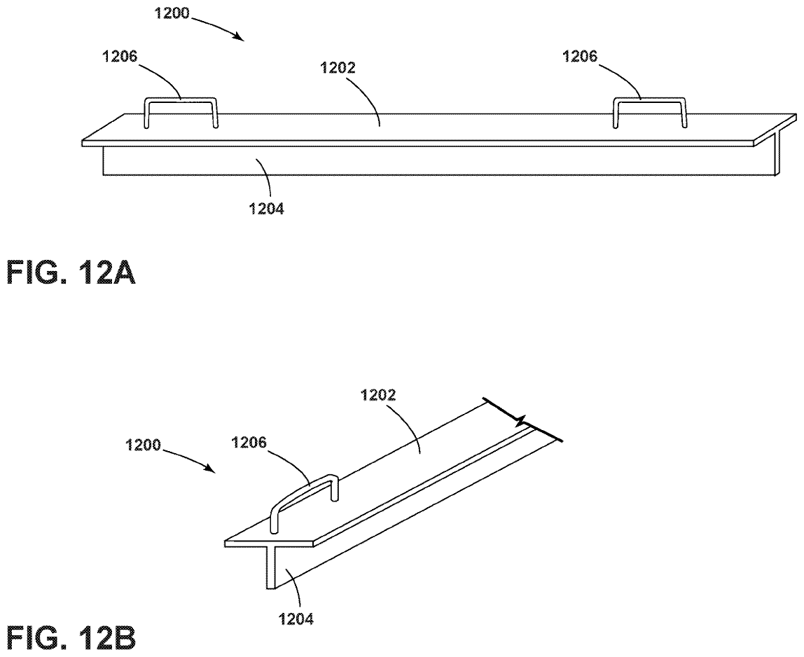

FIG. 14 illustrates an example vehicle 1400 that might be used to tow the trailer 100. The vehicle has a hitch mount 1410 configured to be attached to the hitch 126 on the trailer. In this embodiment, the trailer 100 has a first eddy current tube 1440 attached to a left side portion of a frame of the trailer 100 and a second eddy current tube 1440 attached to a right-side portion of the frame of the trailer 100. The first and second eddy current tubes 1440 should be made of a conductive non-ferrous metal that does not contain significant amounts of iron. As non-limiting examples, the eddy current tubes may be made of copper, aluminum, lead, zinc or brass. The eddy current tubes 1440 may be any desired size and may need to be sized according to the size of the trailer 100 and the towing conditions.

A first sway bar 1420 and a second sway bar 1420 may each have a first end inserted into the first eddy current tube 1440 and second eddy current tube 1440 respectively. FIG. 14 illustrates the sway bars 1420 and eddy current tubes 1440 before the sway bars 1420 are inserted into the eddy current tubes 1440. The sway bars 1420 may be inserted into the eddy current tubes 1440 as the vehicle 1400 backs into position to be attached to the hitch 126. The sways bars 1420 should be very strong and made of a metal, such as steal. The ends of the sway bars 1420 inserted into the eddy current tubes 1440 may have an attached strong permanent magnet 1430.

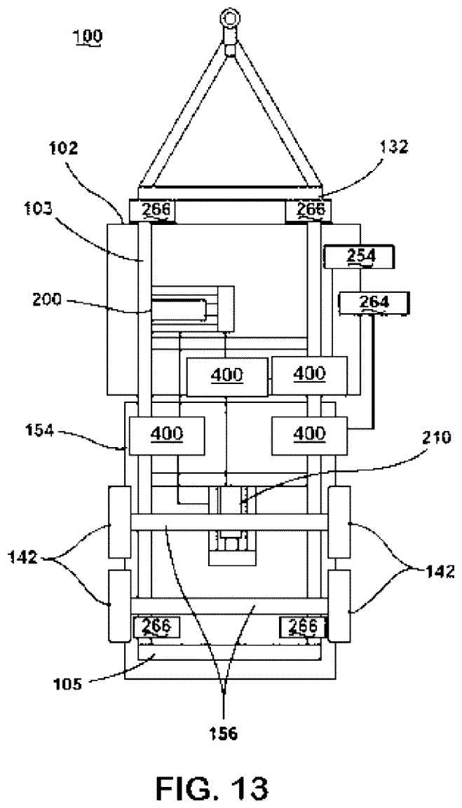

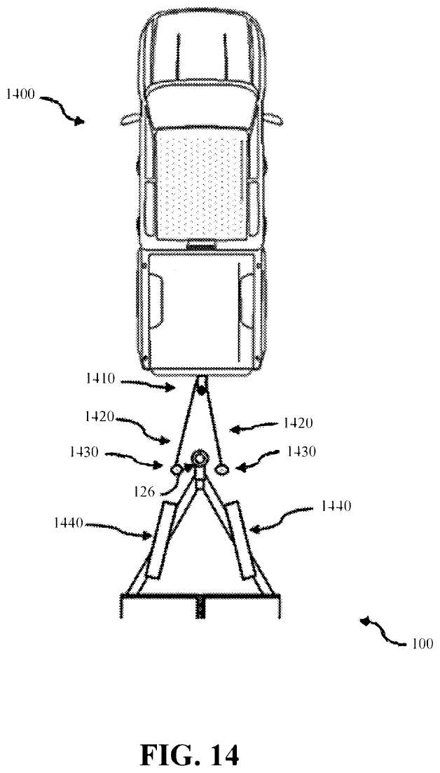

FIG. 15 illustrates a view of just a single eddy current tube 1440 and a single sway bar 1420 with a magnet 1430 once the sway bar 1420 (and its attached magnet 1430) has been inserted into the eddy current tube 1440. FIG. 16 illustrates a cross-section view of the eddy current tube 1440 with an inserted sway bar 1420 and attached permanent magnet 1430.

When a vehicle 1400 is towing a trailer 100 without sway bars, corners or uneven roads may cause the trailer 100 to sway from side to side. The embodiments illustrated in FIGS. 14-16 help to stabilize the trailer 100. If the vehicle 1400 corners to the left, the left sway bar 1440 may be pushed further into its eddy current tube 1440 while the right sway bar 1440 may be pulled further out of its eddy current tube 1440. A right corner will have the opposite effect. The eddy current tubes 1440 should be of sufficient length so that the permanent magnet 1430 attached to the sway bars 1440 never fully exits the eddy current tubes 1440.

When the permanent magnets 1430 moves within the eddy current tubes 1440 a magnetic field is produced according to Faraday's Law which tells us that any change in the magnetic environment of the eddy current tubes 1440 will cause a voltage to be induced in the eddy current tubes 1440. The induced voltage will cause a magnetic field according to Lenz's Law. Lenz's law states that when an electromagnetic field is generated by a change in magnetic flux according to Faraday's law, the polarity of the induced electromagnetic field is such that it produces a current whose magnetic field opposes that change which produces it. The opposition of the magnetic fields produced by the magnet cause magnetic braking.

Thus, when the vehicle 1400 takes a hard corner and the magnet 1430 moves rapidly within the eddy current tubes 1440 a large braking force, yet with some give, is produced. When the trailer is going straight or takes a softer corner, the magnet 1430 will move slower within the eddy current tubes 1440 and produce a smaller braking force. In this manner, the eddy current tubes 1440, magnets 1430 and sway bars 1420 may produce an appropriately sized braking force between the trailer 100 and the hitch mount 126 of the vehicle 1400.

The multi-bed dump trailer 100 may include attachment points for one or more ramps. Ramps may assist with loading wheeled equipment (e.g. lawnmower, skid steer). Attachment points may be placed on the forward dump bed 102 or the rearward dump bed 154. Attachment points may facilitate reversible coupling of a ramp to an edge of a trailer bed.

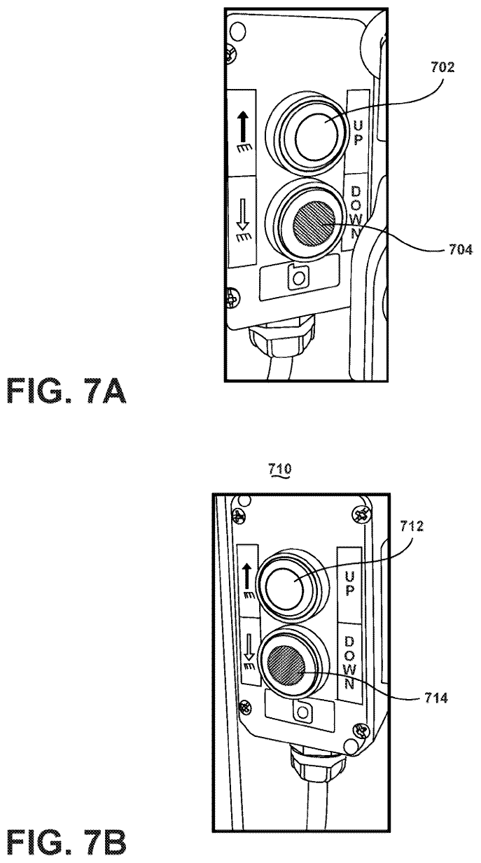

A jack 130 may be attached at the forward end of the multi-bed dump trailer 100. The jack 130 may be used to support the multi-bed dump trailer 100 when not attached to a vehicle. The jack 130 may be used to raise and lower the front end of the multi-bed dump trailer 100 to allow coupling and decoupling of the hitch 126 to a vehicle. The jack 130 may be a manual jack, a pneumatic jack, a hydraulic jack, or any kind of jack. A single jack may be used (see FIG. 1), or a dual jack (see FIG. 8). An auxiliary jack 128 may also be removably attached to the multi-bed dump trailer 100. The auxiliary jack may be removably coupled to the frame 132.

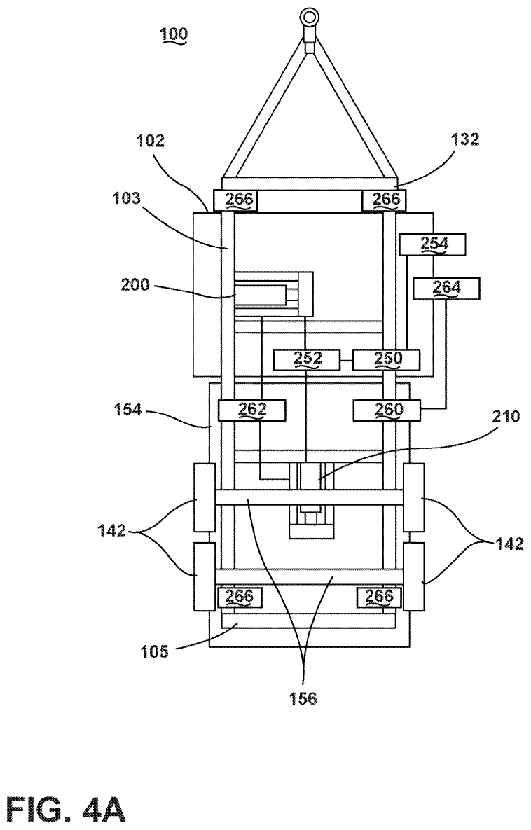

FIG. 4A depicts a simplified underside diagram of the multi-bed dump trailer 100. An axle configuration may comprise a single axle, a dual axle, or any other configuration. The one or more axles 156 may serve as a means to transfer weight from the frame 132 to the wheels 142. The axles 156 may be rotationally coupled to the frame 132. Each axle 156 may be coupled to two or four wheels 142, as in single-wheel or dual-wheel configuration.

Forward bed 102 is coupled to frame 132 by a hinge coupling 103 that runs along a length of frame 132. The configuration of hinge coupling 103 enables forward bed 102 to operate as a side-dump bed. Similarly, rear bed 154 is coupled to frame 132 by hinge coupling 105 that runs laterally across the width of frame 132. The configuration of hinge coupling 105 enables rear bed 154 to operate as a rear-dump bed. In this configuration, hinge coupling 103 is largely perpendicular to hinge coupling 105.

A forward lift mechanism 200 may be used to raise the forward bed 102 and a rearward lift mechanism 210 may be used to raise the rearward bed 154. The two lift mechanisms 200 and 210 may be identical or different. The lift mechanisms 200 and 210 may each be a hydraulic lift, hydraulic actuator, pneumatic lift, pneumatic actuator, electromagnetic actuator, electromagnetic ram actuator or any other kind of lift. The lift mechanisms 200 and 210 may each be telescopic, dual-piston, scissor, ram, or any configuration of lift; and may comprise any arrangement of pistons, cylinders, and hinges. The lift mechanisms 200 and 210 may both be rotationally coupled to the frame 132 and may each be rotationally coupled to the dump beds 102 and 154 respectively.

The lift mechanisms 200 and 210 may use a gravity-down return mechanism or a power-down return mechanism. A gravity-down return mechanism may allow reduced cost, reduced weight, or reduced power usage. A power-down return mechanism may allow greater control over the bed pitch and the return speed regardless of bed load weight and bed load distribution. A power-down return mechanism may be employed to improve performance when loading equipment (e.g. lawnmower, skid steer) onto a dump bed, as it may allow the bed pitch and the return speed of lowering to be readily controlled. An embodiment may use a gravity-down return mechanism for forward lift mechanism 200 and a power-down return mechanism for rearward lift mechanism 210.

In embodiments in which the lift mechanisms 200 and 210 are hydraulic or pneumatic, the operating pumps connected to lift mechanisms 200 and 210 may be connected to both forward bed 102 and rearward bed 154 by valve mechanisms enabling each one of lift mechanisms 200 and 210 to be operated should one of the operating pumps fails.

To illustrate, pump 250 is coupled through valve 252 to both lift mechanism 200 and 210. In a default value position, pump 250, when operated by control interface 254, may control the operation of lift mechanism 200. However, if the position of valve 252 is changed, pump 250 may instead be coupled to lift mechanism 210. Conversely, pump 260 is coupled through valve 262 to both lift mechanism 200 and 210. In a default value position, pump 260, when operated by control interface 264, may control the operation of lift mechanism 210. However, if the position of valve 262 is changed, pump 260 may instead be connected to lift mechanism 200.

In a similar manner, control interfaces 254 and 264 may be connected via appropriate electrical switches (not shown in FIG. 4A) to selectively control the operation of either pump 250 or pump 260. In this manner, control interfaces 254 and 264 can also act as back-ups for one another, should a control interface 254 or 265 fail.

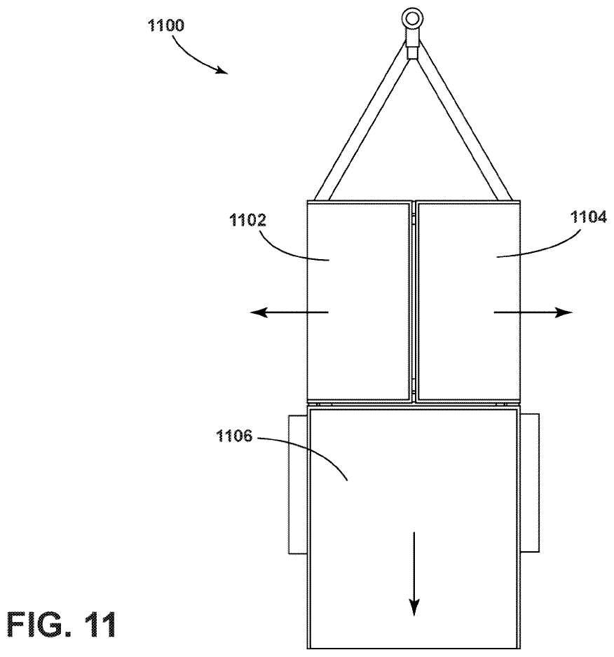

FIG. 13 illustrates an embodiment where one or both lift mechanisms 200 and 210 are electromagnetic rams or actuators (hereafter electromagnetic rams). Electricity for the electromagnetic rams may be provided by batteries 400, a generator or from an engine of a vehicle, possibly the vehicle that is towing the trailer 100. The batteries 400 and/or generator may be attached to the trailer 100 as desired.

In some embodiments, the battery system may include standard auto, boat, car, recreational vehicle, deep cycle, and power tool batteries to power the hydraulic lift, hydraulic actuator, pneumatic lift, pneumatic actuator, electromagnetic actuator, electromagnetic ram actuator. Alternatively, the battery system may also be used to recharge power tool batteries that are electrically connected to the battery system.

The electromagnetic ram may be of any desired type where the movement of the ram is linear to raise a portion of the dump bed 102 or 154. The electromagnetic ram may be an electromagnetic device that converts electrical energy into a mechanical pushing or pulling force or motion. The electromagnetic ram includes an electromagnet which may be a coil of copper wire with applied electricity. An iron core may be placed inside the coil of wire. When electricity is applied to the coil of wire in a first direction a first magnetic field is created that pushes the iron core and a connected ram and when electricity is applied to the coil in a second direction a second magnetic field is created that pulls the iron core and the connected ram. Increasing the current in the coils increases the magnetic field which increases the pushing or pulling force of the ram. In this manner, the electromagnetic ram may raise and lower the dump bed 102 or 154 of the trailer 100 in a controlled manner.

In other embodiments, the electromagnetic ram may use an electromagnet that pushes against another electromagnet (flipped so that a positive end of one electromagnet is opposite a positive end of the other electromagnet or a negative end of one electromagnet is opposite a negative end of the other electromagnet) to generate a pushing force against the ram that lifts a dump bed. In yet other embodiments, an electromagnetic ram may use an electromagnet that pushes against a permanent magnet to generate a pushing force against the ram that lifts a dump bed.

It should be appreciated that the described electromagnetic rams may be used to raise one, two, three or any number of dump beds and may even be used in vehicles that only have a single dump bed or no dump beds, but still use electromagnetic rams in other applications.

In some embodiments, the electromagnetic ram may only need to be able to push in one direction to raise the dump bed 102 or 154 and gravity (combined with a lower current and thus pushing force from the electromagnetic ram) may be used to lower the dump bed 102 or 154.

The control interfaces 254 and 264 may be connected via appropriate electrical switches to selectively control the operation of the electromagnet ram by controlling the voltage (and thus the current) and polarity of the electricity applied to the electromagnetic ram.

To increase trailer stability during dumping (and, particularly, side dumping) a number of jacks 266 may be positioned about a perimeter of frame 132 of trailer 100.

FIG. 4B depicts a simplified top view diagram of the multi-bed dump trailer 100 of FIGS. 1 and 2. Trailer 100 includes forward dump bed 102 and rearward dump bed 154. Forward dump bed 102 includes a number of walls 402 running about a perimeter of forward dump bed 102. Rearward dump bed 154 includes a number of walls 404 running about a perimeter of rearward dump bed 102. In the configuration depicted in FIG. 4B, each of forward dump bed 102 and rearward dump bed 154 include internal doors or gates form positioned in interior walls 402 and 404 of forward dump bed 102 and rearward dump bed 154, respectively. For example, forward dump bed 102 includes doors 406 and 408 arranged in a wall 402 of forward dump bed 102 that is rearmost of forward dump bed 102. Similarly, door 410 is positioned in the most forward wall 404 of rearward dump bed 154. In this combination, if doors 406, 408 and 410 are opened fully, a large interior area comprising portions of the volume of both forward dump bed 102 and rearward dump bed 154 becomes accessible. That interior area may be sized to receive material or equipment, such as a skid steer, enabling transportation of the same using trailer 100.

In this configuration, the wall 402 containing doors 406 and 408 and the wall 404 containing door 410 are generally in parallel and positioned relatively close to one another. In embodiments, the distance between the two walls is generally less than 3 feet and sometimes less than 1 foot, although different geometrical configurations are contemplated in which the distance between the walls is larger or smaller.

Trailer 100 includes loading chute 110. As illustrated in FIG. 4B, loading chute 110 can be coupled to a support 412 that runs laterally across the width of trailer 100. Chute 110 may, in some embodiments, be slidably coupled to support 412 enabling lateral repositioning of chute 110 with respect to trailer 100. Such lateral movement is indicated by arrow 414 shown in FIG. 4B.

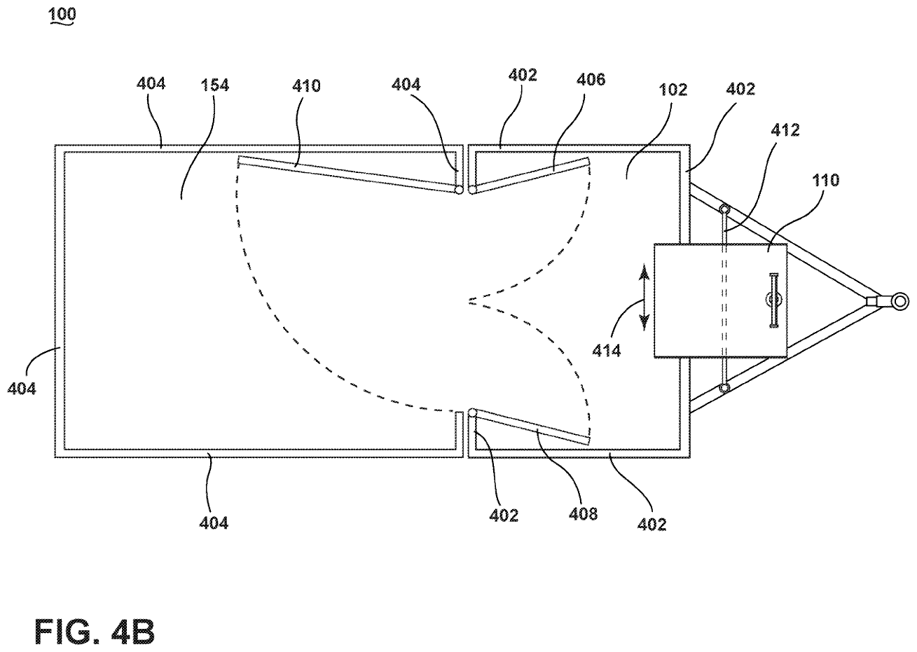

FIG. 5 shows a rear side perspective view of multi-bed dump trailer 100 with forward bed 102 and rearward bed 154 both in a raised position. Rear gate latch 158 is visible in the center of rear dump gate 152, which is a barn door gate in this embodiment. Forward lift mechanism 200 is visible under forward bed 102. Tarp bar holders 150 are not shown.

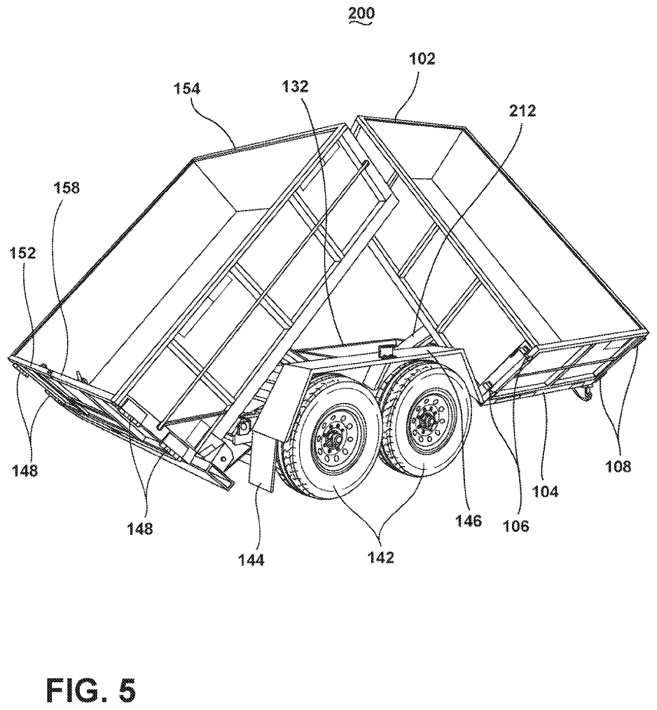

As shown in FIG. 6, one or more batteries 602 may be mounted on multi-bed dump trailer 100. Each battery 602 may be mounted on a battery holder 604. Battery holders 604 may be rigidly coupled to frame 132. Batteries 602 may be electrically connected to one or more hydraulic pump assemblies 606. Hydraulic pump assembly 606 may include hydraulic pump and hydraulic fluid reservoir.

Electrical connections from batteries 602 to hydraulic pump assemblies 606 or may include any arrangement of fuses, breakers, and switches. A switch may allow selective modification of electrical connections. An example of such a modification may include adjusting which battery 602 is connected to which hydraulic pump assembly 606, such as for bypassing a discharged battery. This example modification would temporarily preclude independent operation of two dump beds 102 and 154.

Each hydraulic pump assembly 606 may be hydraulically connected to a respective lift mechanism 200 or 210. Lift mechanisms 200 and 210 may each include any arrangement of hydraulic cylinders, hydraulic pistons, rotational bearings, and legs.

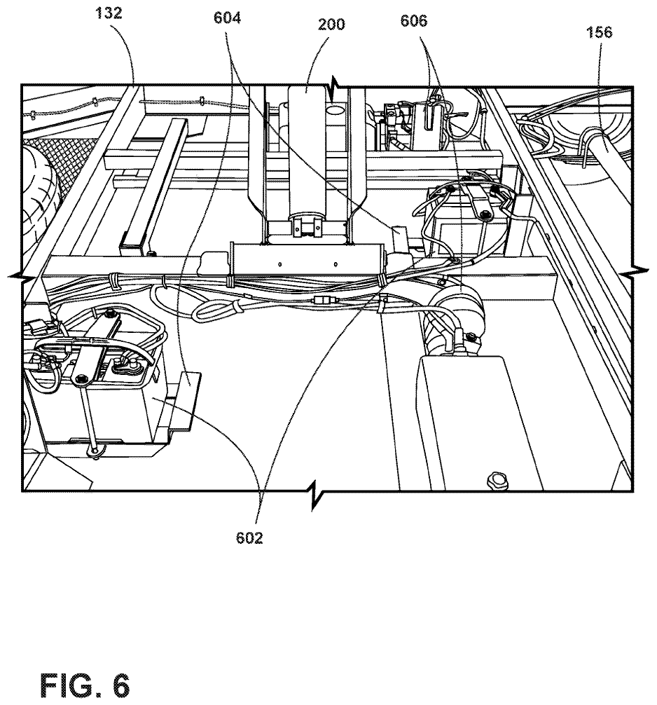

Each hydraulic pump assembly 606 may be electrically connected to a respective controller. A first controller 700 as shown in FIG. 7A may be used to control a hydraulic pump assembly 606 hydraulically connected to forward lift mechanism 200. A second controller 710 as shown in FIG. 7B may be used to control a hydraulic pump assembly 606 hydraulically connected to rearward lift mechanism 210. The first controller may comprise an UP button 702 and a DOWN button 704. When pressed, buttons 702 and 704 may instruct the corresponding hydraulic pump assembly 606 to respectively apply and release pressure and thereby respectively raise and lower the forward lift mechanism 200. Similarly, when pressed, buttons 712 and 714 may instruct the corresponding hydraulic pump assembly 606 to respectively apply and release pressure and thereby respectively raise and lower the rearward lift mechanism 210. The controllers 700 and 710 may operate independently, allowing for each dump bed 102 and 154 to be raised or lowered regardless of the position of the other dump bed 154 and 102 respectively.

As shown in FIG. 8, an embodiment of a multi-bed trailer 800 may comprise tandem side-by-side rear dump beds 802. The tandem rear dump beds 802 may have spreader gates or any kind of dump gate. An embodiment may have a forward deck 804, which may be configured for hauling equipment or packaged loads. The forward deck 804 may have any configuration of fixed sides, removable sides 806, folding ramps 808, and removable ramps. The multi-bed dump trailer 800 may have dual forward jacks 810 or any configuration of one or more jacks. The multi-bed dump trailer may have a gooseneck hitch 812 or any configuration of hitch.

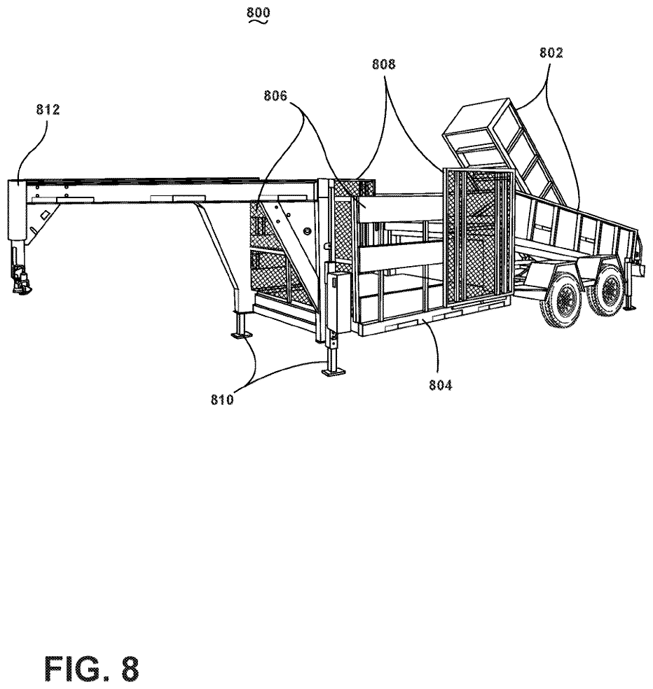

As shown in FIG. 9, multi-bed dump trailer 800 may additionally comprise right and left rear jacks 814 (only the right is visible). Rear jacks 814 may be hydraulic powered or manually powered. Rear jacks 814 may be lowered to improve the stability of the multi-bed dump trailer 800 during a dumping operation. Stability may be important during dumping operations wherein the beds 802 may be raised at different times or heights and therefore apply an asymmetric load to trailer 800. Rear jacks 814 may be raised or may be removed to allow movement of the multi-bed dump trailer 800.

Each dump bed 802 may comprise a rear spreader gate 816 or any configuration of dump gate. Tarp bar holders 818 may be coupled near the left edge of the left spreader gate 816 and the right edge of the right spreader gate 816.

All prior description of multi-bed dump trailer 100 having forward and rearward dump beds 102 and 154 may be equivalently applied to a multi-bed dump trailer 800 having tandem rear dump beds 802. Multi-bed dump trailer 800 may have independent hydraulic controls.

In various embodiments of the present trailer system, additional functionality may be incorporated into the trailer. For example, in some embodiments, additional mechanisms, such as a cable spool jack could be mounted to a frame of the trailer to enable the transport of cable (e.g., fiber optic, electric, and the like) in conjunction with materials loaded into one of the multiple beds of the trailer. To illustrate this optional configurations, FIGS. 10A and 10B show example cable spool jacks 1051 that could be mounted to forward dump bed 1004 and/or rearward dump bed 1006.

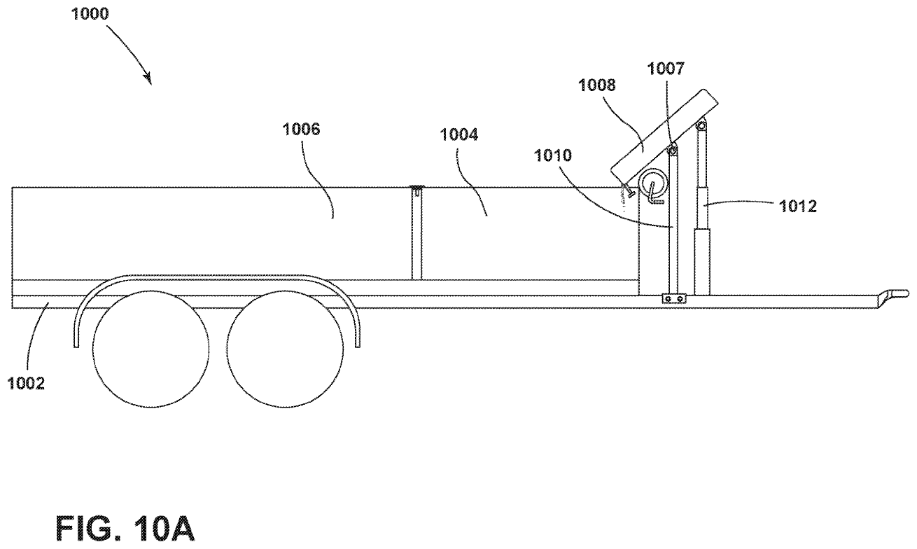

In some embodiments, the trailer system may include more than two dump beds. FIG. 11 depicts an example trailer 1100 system that includes three dump beds. Some of the components of trailer 1100, such as the frame construction, lift mechanisms, and the like may be similar to those discussed above. Trailer 1100 includes two forward dump beds 1102 and 1004 and a rearward dump bed. Dump bed 1102 may be configured to dump over a left side of trailer 1000, while dump bed 1104 may be configured to dump over a right side of trailer 1100. Rearward dump bed 1106 may be configured to dump over either side of trailer 1100 or over a rear end of trailer 1100, depending on how rearward dump bed 1006 is mounted to the frame of trailer 1100. Trailer 1000 may include a chute (e.g., chute 110) to facilitate loading of one or more of beds 1102, 1104, and/or 1106. Trailer 1000 may include a number of stability jacks (e.g., jacks 266) to improve trailer stability when loading or dumping material.

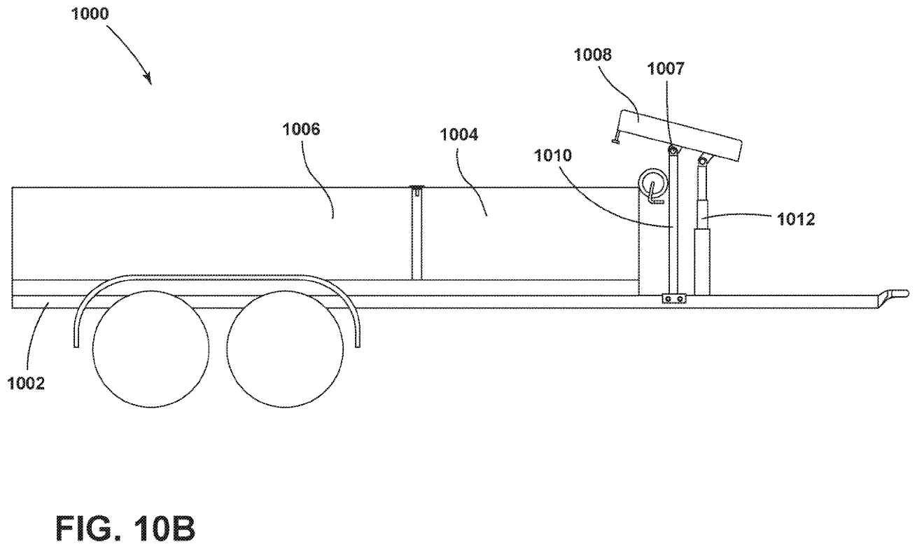

When loading the present trailer system, there is a potential for material being loaded to fall between the multiple trailer beds. To mitigate this problem, FIGS. 12A and 12B depict a perspective and side views, respectively, of a fall-through protector 1200. Protector 1200 includes a horizontal portion 1202 coupled to a vertical plate 1204. Protector 1200 includes handles 1206 to facilitate lifting and placement of protector 1200.

When using protector 1200, a user uses handles 1206 to life protector 1200 and place the protector 1200 into the gap between trailer beds (e.g., the gap between forward dump bed 102 and rearward dump bed 154 or any of the gaps between dump beds 1102, 1104, and 1106 of FIG. 11 when the dump beds are in their lowered position. Specifically, the vertical plate 1204 of protector 1200 is inserted into the gap between dump beds so that the horizontal portion 1202 rests upon the walls of the dump beds on either side of the gap. In this position, protector 1200 can prevent material from falling into the gap between dump beds when either dump bed is filled with material.

The trailer 100, dump beds 102, 154, 802, 1004, 1006 bed liners, dump bed floors, dump bed walls for dump trailers, having any number of desired dump beds 102, 154, 802, 1004, 1006 or trucks may be made of any desired material. As non-limiting examples, the trailer 100, dump beds 102, 154, 802, 1004 1006, bed liner, dump bed floor, dump bed walls or trucks may be made of metal (such as iron, steel or stainless steel). In other embodiments, the trailer 100, dump beds 102, 154, 802, 1004, 1006, bed liner, dump bed floor, dump bed walls or trucks may be made of fiberglass, polyethylene, poly carbon, polyurethane, plastic, Kevlar, carbon fibers, wood, concrete, silicon carbide, graphene, titanium alloys or metallic glass.

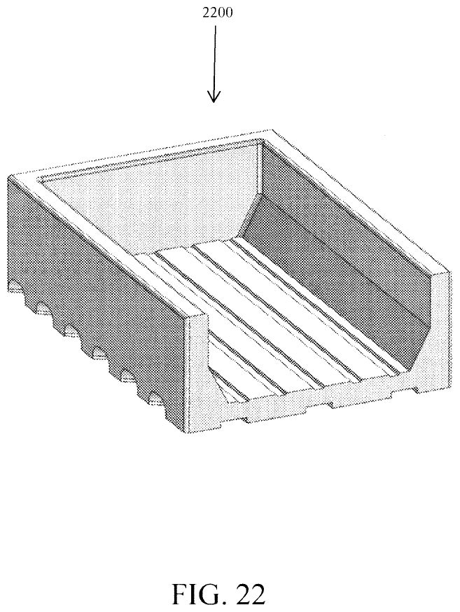

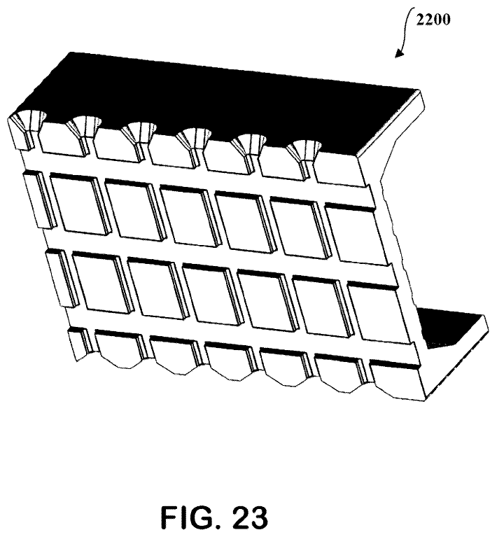

Referring to FIGS. 22 and 23, the illustrated dump bed 2200 may be used with a truck or a trailer and have any desired length. As a non-limiting example, the dump beds 2200 may be between 6 feet and 20 feet long. The dump bed 2200 may have integrated metal supports and non-integrated metal supports. The dump bed 2200 may be created using any desired technique. As non-limiting examples, the dump bed 220 may be produced by using either roto molding, vacuum molding or injection molding. In preferred embodiments, the dump bed 2200 is made from a poly material, a polymer or a plastic, such as polyethylene or plypropylene.

In accordance with an embodiment, a trailer 100 includes a metal frame, a first dump bed coupled to the frame substantially near a forward end of the frame, and a second dump bed 154 coupled to the frame substantially near a rearward end of the frame. In an embodiment, the first dump bed 102 is a side-dumping dump bed and the second dump bed 154 is a rear-dumping dump bed. In an embodiment, the first dump bed 102 is coupled to the metal frame by a first hinge and the second dump bed 154 is coupled to the metal frame by a second hinge and an axis of the first hinge is perpendicular to an axis of the first hinge. In an embodiment, the trailer 100 includes a loading chute coupled to the frame forward of the first dump bed 102, wherein the loading chute is coupled to the frame by one or more hinges such that the loading chute may be selectively placed in a lowered position and in a raised position substantially above the first bed. In an embodiment, the first dump bed 102 and the second dump bed 154 are independently controlled. In an embodiment, the trailer 100 includes a first electromagnetic ram coupled to the first dump bed 102 and the second dump bed 154 and being configured to selectively control a position of the first dump bed 102 and the second dump bed 154 and a second electromagnetic ram coupled to the first dump bed 102 and the second dump bed 154 and being configured to selectively control a position of the first dump bed 102 and the second dump bed 154. The trailer 100 may include a control interface configured to selectively operate either the first electromagnetic ram or the second electromagnetic ram. In an embodiment, the first dump bed 102 includes a first plurality of walls and a first wall of the first plurality of walls includes a first door, the first wall of the first plurality of walls being perpendicular to a length of the trailer 100. The second dump bed 154 may include a second plurality of walls and a second wall of the second plurality of walls includes a second door, the second wall of the second plurality of walls being perpendicular to a length of the trailer 100. A maximum distance between the first wall of the first dump bed 102 and the second wall of the second dump bed 154 may be less than 3 feet.

In an embodiment, a trailer 100 includes a frame 1002, a first dump bed 102 coupled to the frame, a second dump bed 154 coupled to the frame, and a control system configured to independently operate either the first dump bed 102 or the second dump bed 154. The trailer 100 may have attached two eddy current tubes each configured to receive a magnet end of a sway bar to stabilize the trailer 100 while being towed by a vehicle. In an embodiment, the first dump bed 102 is a side-dumping dump bed and the second dump bed 154 is a rear-dumping dump bed. In an embodiment, the first dump bed 102 is coupled to the metal frame by a first hinge and the second dump bed 154 is coupled to the metal frame by a second hinge and an axis of the first hinge is perpendicular to an axis of the first hinge. The trailer 100 may include a loading chute coupled to the frame forward of the first dump bed 102, wherein the loading chute is coupled to the frame by one or more hinges such that the loading chute may be selectively placed in a lowered position and in a raised position substantially above the first bed. In an embodiment, the trailer 100 includes a first hydraulic actuator coupled to the first dump bed 102 and the second dump bed 154 and being configured to selectively control a position of the first dump bed 102 and the second dump bed 154 and a second hydraulic actuator coupled to the first dump bed 102 and the second dump bed 154 and being configured to selectively control a position of the first dump bed 102 and the second dump bed 154. The control system may include a control interface configured to selectively operate either the first hydraulic actuator or the second hydraulic actuator. In an embodiment, the first dump bed 102 includes a first plurality of walls and a first wall of the first plurality of walls includes a first door, the first wall of the first plurality of walls being perpendicular to a length of the trailer 100. The second dump bed 154 may include a second plurality of walls and a second wall of the second plurality of walls includes a second door, the second wall of the second plurality of walls being perpendicular to a length of the trailer 100. In some embodiment, a maximum distance between the first wall of the first dump bed 102 and the second wall of the second dump bed 154 is less than 3 feet.

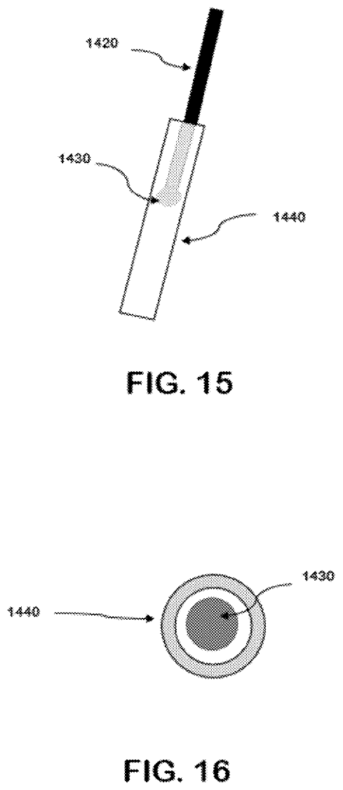

Referring to FIG. 17, a side view of a multi-bed dump trailer 100 is illustrated with the forward dump bed 102 and the rearward dump bed 154 in lowered positions. This is the preferred position of the forward dump bed 102 and rearward dump bed 154 when the multi-bed dump trailer 100 is being pulled by a vehicle. For descriptive purposes, “forward” refers to the front of the multi-bed dump trailer 100 with the hitch mount 1410 and “rearward” refers to the back of the multi-bed dump trailer 100 opposite of the hitch mount 1410. “Sideways” refers to a direction perpendicular to the axis of the multi-bed dump trailer. The illustrated forward dump bed 102 and rearward dump bed 154 may be any desired sizes as long as the combination fits on the subframe 1710. As non-limiting example, the forward dump bed 102 may be the same size as the rearward dump bed 154 or the forward dump bed 102 may be half the size of the rearward dump bed 154. In preferred embodiments, the forward dump bed 102 has a first spreader gate for allowing material to exit sideways from the forward dump bed 102 and the rearward dump bed 154 has a second spreader gate for allowing material to exit rearward from the rearward dump bed 154.

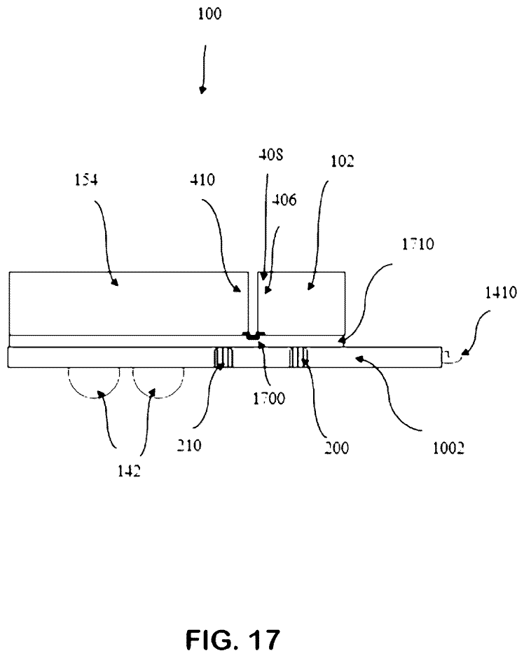

Referring to FIG. 18, a side view of the multi-bed dump trailer 100 is illustrated with the forward dump bed 102 and the rearward dump bed 154, both mounted on the subframe 1710, is in a raised, i.e., tilted, position. Material may be dumped from the forward dump bed 102 and the rearward dump bed 154 when the forward dump bed door(s) 406, 408 and the rearward dump bed door(s) 410 are open. In preferred embodiments, the seal insert 1700 is installed between the forward dump bed 102 and the rearward dump bed 154) when dumping from both the forward dump bed 102 and the rearward dump bed 154 to prevent spillage between them. Alternatively, material may be dumped rearward from only the rearward dump bed 154 when the forward dump bed door(s) 406, 408 and the rearward dump bed door(s) 410 are closed even when the forward dump bed 102 contains material.

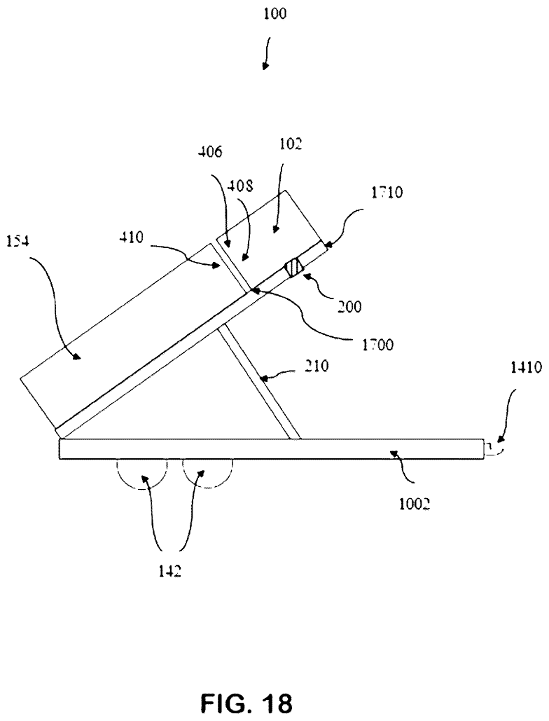

Referring to FIG. 19, a rearward view of the multi-bed dump trailer 100 is illustrated with the forward dump bed 102 in a raised sideways position to dump material sideways from the forward dump bed 102. The rearward dump bed 154 is illustrated in a lowered position to not dump material. A forward lift mechanism 200 may be used to raise, i.e., tilt, the forward dump bed 102 into the illustrated raised position which allows gravity to assist in removing material from the forward dump bed 102.

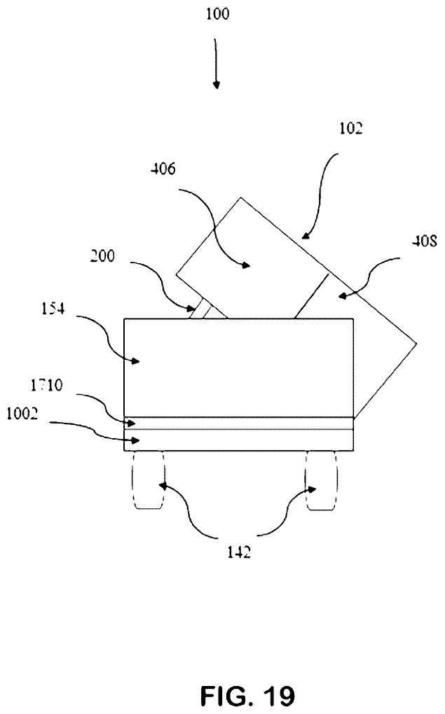

Referring to FIG. 20, a side view of a seal insert 1700 is illustrated that may be installed between the forward dump bed 102 and the rearward dump bed 154. The seal insert 1700 is useful when dumping material from the forward dump bed 102 and the rearward dump bed 154 at the same time in a rearward direction. The seal insert 1700 prevents material from falling between the forward dump bed 102 and the rearward dump bed 154 when installed.

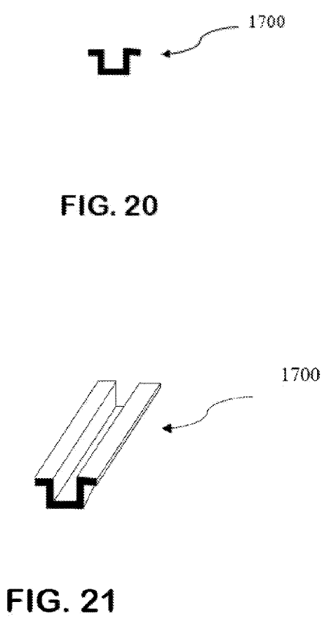

Referring to FIG. 21, a perspective view of the seal insert 1700 illustrated in FIG. 17 and FIG. 20 is illustrated.

In an embodiment of the present disclosure, a multi-bed dump trailer 100 may include a forward dump bed 102, a rearward dump bed 154, a subframe 132 for connecting and supporting the forward dump bed 102 and the rearward dump bed 154, a frame 1002 for supporting the subframe 132, a plurality of wheels 142, a forward lift mechanism 200 connected to the frame 1002 and the forward dump bed 102 and a rearward lift mechanism 210 connected to the frame 1002 and the subframe 132. The multi-bed dump trailer 100 may dump material in the forward dump bed 102 sideways through a first spreader gate at a first time, dump material in the rearward dump bed 154 rearward through a second spreader gate at a second time and dump material in the forward dump bed 102 and the rearward dump bed 154 through the second spreader gate rearward at a third time. The first time, second time and third time are preferably at different times. This flexibility in having three different dump modes or configurations greatly increases the utility of the multi-bed dump trailer 100.

In another embodiment, the multi-bed dump trailer 100 may include a forward dump bed 102, wherein the forward dump bed 102 has one or more doors 406, 408 arranged in a most rearward wall of the forward dump bed 102. The multi-bed dump trailer 100 may also include a rearward dump bed 154, wherein the rearward dump bed 154 may have one or more doors 410 arranged in a most forward wall of the rearward dump bed 154. The doors 406, 408, 410 in the forward dump bed 102 and the rearward dump bed 154 permit material in the forward dump bed 102 to pass through to the rearward dump bed 154. In preferred embodiments, the forward dump bed 102 and rearward dump bed 154 are shaped as open boxes or rectangular prisms that are open on top.

The multi-bed dump trailer 100 may also include a subframe 132, wherein the forward dump bed 102 and the rearward dump bed 154 are securely connected (but the forward dump bed 102 may have the ability to be raised, pivoted or tilted on the subframe 132) to the subframe 132. The subframe 132 is preferably metal as it supports the weight of the forward dump bed 102, the rearward dump bed 154 and any material therein. The subframe 132 may comprise at least four metal members connected to form a hollow rectangle shape, preferably the same width, but shorter, than the trailer it lays on. Additional support members may be added to the subframe 132 as needed.

The subframe 132 may be connected to the frame 1002 by any desired means but is preferably connected by hinges or other mechanical means on the rearward side of the frame 1002 which allow a forward part of the subframe 132 to be raised while pivoting on the rearward side, thereby tilting the subframe 132, the forward dump bed 102 and the rearward dump bed 154 in a rearward direction. This allows the forward dump bed 102 and the rearward dump bed 154 to be raised and lowered together on the subframe 132 with the rearward lift mechanism 210.

The multi-bed dump trailer 100 may also have the frame 1002 for supporting the subframe 132 and a plurality of wheels 142 that allow the multi-bed dump trailer 100 to be pulled behind a vehicle. The frame 1002 may also include a hitch mount 1401 configured to allow a vehicle to connect to and tow the multi-bed dump trailer 100.

The multi-bed dump trailer 100 may have a first configuration where a forward lift mechanism 200 is connected to the forward dump bed 102 and configured to raise one of either a left side or a right side of the forward dump bed 102 to dump material in the forward dump bed 102 through a spreader gate in a sideways direction in relation to the multi-bed dump trailer 100.

The multi-bed dump trailer 100 may have a second configuration where a rearward lift mechanism 210 is connected to the subframe 132 and is configured to raise a front of the subframe 132 to dump material in the forward dump bed 102 and the rearward dump bed 154 in a rearward direction together at the same time when the one or more doors of the forward dump bed 102 and the one or more doors of the rearward dump bed 154 are open.

The multi-bed dump trailer 100 may have a third configuration where the rearward lift mechanism 210 is connected to the subframe 132 and is configured to raise the front of the subframe 132 to dump material in the rearward dump bed 154 (but not dump the material in the forward dump bed 102) in a rearward direction through the second spreader gate when the one or more doors of the forward dump bed 102 and the one or more doors of the rearward dump bed 154 are closed.

The multi-bed dump trailer 100 may include a seal insert 1700 installed between the forward dump bed 102 and the rearward dump bed 154. This allows material in the forward dump bed 102 to slide into the rearward dump bed 154 without material falling between the forward dump bed 102 and the rearward dump bed 154 when both the forward dump bed 102 and the rearward dump bed 154 are being dumped rearward.

The forward lift mechanism 200 and the rearward lift mechanism 210 of the multi-bed dump trailer 100 may be any desired type of lift mechanism. As non-limiting examples, the forward lift mechanism 200 and the rearward lift mechanism 210 may be a scissor lift mechanism, a piston lift mechanism or any other type of lift mechanism previously described or combination thereof.

The multi-bed dump trailer 100 may have a configuration where the forward dump bed 102 is configured to be tilted towards one of its sides to dump material in a sideways direction at a first time and tilted towards a rearwards direction to dump material in a rearward direction in relation to the multi-bed dump trailer 100 at a second time, where the first time and the second time are at different times.

The multi-bed dump trailer 100 may have a loading chute 1008 coupled to the frame 1002 forward of the forward dump bed 102. The loading chute 1008 may be coupled to the frame 1002 by one or more hinges such that the loading chute 1008 may be selectively placed in a lowered position or in a raised position substantially above the forward dump bed 102.

The forward dump bed 102 may be independently controller at a first time to dump material in a sideways direction through a first spreader gate or the forward dump bed 102 and the rearward dump bed 154 may be controlled together on the subframe 132 to dump material in a rearward direction through a second spreader gate at a second time different from the first time.

In another embodiment, the forward dump bed 102 is both a side-dumping dump bed and a rearward dumping dump bed (not simultaneously, but at different times) and the rearward dump bed 154 is only a rearward dumping dump bed.

The multi-bed dump trailer 100 may also include a control interface configured to selectively operate either the forward lift mechanism 200 or the rearward lift mechanism 210.

The forward dump bed 102 may have one or two inward swinging doors 406, 408 and the rearward dump bed 154 may have one or two inward swinging doors 410. As a non-limiting example, the forward dump bed 102 may have two inward swinging doors 406, 408 and the rearward dump bed 154 may have one inward swinging door 410.

When the door(s) of the forward dump bed 102 are closed, the forward lift mechanism 200 may dump the forward dump bed 102 sideways in relation to the multi-bed dump trailer 100 to remove material from the forward dump bed 102 through the first spreader gate.

When the door(s) of the forward dump bed 102 and the door(s) of the rearward dump bed 154 are open, the forward dump bed 102 and the rearward dump bed 154 may be treated and dumped rearward as a single dump bed through the second spreader gate. The seal insert 1700 may be inserted between the forward dump bed 102 and the rearward dump bed 154 to prevent material from falling between the forward dump bed 102 and the rearward dump bed 154 during a process of dumping the forward dump bed 102 and the rearward dump bed 154 in the rearward direction.

The preceding detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

It should be understood that this invention is not limited in its application to the details of construction and the arrangement of components set forth in the preceding description or illustrated in the accompanying drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The preceding discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The preceding detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

The connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus are not intended to be limiting, and the terms “first”, “second” and other such numerical terms referring to structures do not imply a sequence or order unless clearly indicated by the context.

The foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematic shown in the figures depict one exemplary arrangement of elements, additional intervening elements, devices, features, or components may be present in an embodiment of the depicted subject matter.

As will be appreciated by one skilled in the art, aspects of the present disclosure may be embodied as a system, process, method, and/or program product.

The preceding detailed description is merely illustrative in nature and is not intended to limit the embodiments of the subject matter or the application and uses of such embodiments.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed:

1. A device, comprising:
a frame;
a subframe over the frame;
a forward dump bed coupled to the subframe, wherein the forward dump bed has one or more doors arranged in a most rearward wall of the forward dump bed;
a rearward dump bed coupled to the subframe, wherein the rearward dump bed has one or more doors arranged in a most forward wall of the rearward dump bed;
a first lift mechanism connected to the forward dump bed and configured to raise at least a portion of the forward dump bed to dump material in the forward dump bed in a sideways direction; and
a second lift mechanism configured to raise the subframe to dump material in a rearward direction from at least one of the forward dump bed and the rearward dump bed.

2. The device of claim 1, further comprising a seal insert installed between the forward dump bed and the rearward dump bed.

3. The device of claim 1, wherein the forward lift mechanism is a scissor lift mechanism.

4. The device of claim 1, wherein the rearward lift mechanism is a piston lift mechanism.

5. The device of claim 1, wherein at least one of the forward lift mechanism and the rearward lift mechanism includes an electromagnetic ram.

6. The device of claim 1, wherein the forward dump bed is configured to be tilted towards one of its sides to dump material in a sideways direction at a first time and tilted towards a rearwards direction to dump material in a rearward direction in relation to the frame at a second time.

7. The device of claim 1, wherein the frame is configured to couple to a vehicle.

8. The device of claim 1, wherein the frame is coupled to a vehicle via a hitch connection or a direct connection mounting the device to the bed of a vehicle.

9. The device of claim 1, wherein at least one of the forward dump bed and the rearward dump bed includes a poly material.

10. The device of claim 9, wherein the poly material includes polyethylene or polypropylene.

11. A device, comprising:
a metal frame;
a first dump bed coupled to the frame substantially near a forward end of the frame, wherein the first dump bed is configured to dump materials toward a side of the device; and
a second dump bed coupled to the frame substantially near a rearward end of the frame.

12. The device of claim 11, further comprising: a first lift mechanism coupled to the first dump bed and a second lift mechanism coupled to the second dump bed.

13. The device of claim 11, wherein the first dump bed is coupled to the metal frame by a first hinge and the second dump bed is coupled to the metal frame by a second hinge and a first axis of the first hinge is perpendicular to a second axis of the second hinge.

14. The device of claim 11, wherein the first dump bed includes a first plurality of walls and a first wall of the first plurality of walls includes a first door, the first wall of the first plurality of walls being parallel to a length of the device.

15. The device of claim 14, wherein the second dump bed includes a second plurality of walls and a second wall of the second plurality of walls includes a second door, the second wall of the second plurality of walls being perpendicular to the length of the device.

16. The device of claim 5, wherein a maximum distance between the first wall of the first dump bed and the second wall of the second dump bed is less than 3 feet.

17. The device of claim 11, wherein at least one of the forward dump bed and the rearward dump bed includes a poly material.

18. The device of claim 17, wherein the poly material includes polyethylene or polypropylene.

19. The device of claim 11, wherein the frame is configured to couple to a vehicle via a hitch connection or is mounted to the bed of a vehicle.
